(19) United States
(12) Patent Application Publication
(10) Pub. No.: US 2021/0078332 A1
(43) Pub. Date: Mar. 18, 2021

(54) FLUIDIC DIE PURGING

(71) Applicant: Hewlett-Packard Development Company, L.P., Spring, TX (US)

(72) Inventors: Daryl E. Anderson, Corvallis, OR (US); Eric Martin, Corvallis, OR (US); James Michael Gardner, Corvallis, OR (US); Pere Esterri Pedra, Sant Cugat del Valles (ES)

(73) Assignee: Hewlett-Packard Development Company, L.P., Spring, TX (US)

(21) Appl. No.: 16/970,491

(22) PCT Filed: Apr. 12, 2018
(86) PCT No.: PCT/US2018/027354

§ 371 Date: Aug. 17, 2020

(51) Int. Cl. B41J 2/165; B33Y 30/00; B33Y 40/00; B33Y 50/02; B29C 64/209; B29C 64/35; B29C 64/393

(52) U.S. Cl. CPC B41J 2/16517; B33Y 30/00; B33Y 40/00; B29C 64/393; B29C 64/209; B29C 64/35; B33Y 50/02

(57) ABSTRACT

A fluidic die may include a fluidic channel, and an electrode disposed within a fluidic channel of the fluidic die to determine if a difference between an initially-measured impedance and a subsequently-measured impedance as measured by the electrode indicates a completion of a purging of an initial fluid from the fluidic die and a replacement with a second fluid.

### BACKGROUND

A fluidic die may be used to move fluids within the fluidic die, eject fluids onto media, or combinations thereof. The fluids within a fluidic die may include any fluid that may be moved within or ejected from the fluidic die. For example, the fluids may include inks, dyes, chemical pharmaceuticals, biological fluids, gases, and other fluids. The fluids may be used to print images on media or effectuate chemical reactions between different fluids, for example. Further, in additive manufacturing processes such as those that use a three-dimensional (3D) printing device, the fluidic die may eject build materials, adhesives, and other fluids that may be used to build a 3D object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluidic die, according to an example of the principles described herein.

FIG. 2 is a block diagram of a fluid detection device, according to an example of the principles described herein.

FIG. 3 is a block diagram of a fluid detection device, according to an example of the principles described herein.

FIG. 4 is a side cut-away block diagram of a fluidic die including an amount of initial fluid, according to an example of the principles described herein.

FIG. 5 is a side cut-away block diagram of a fluidic die including an amount of initial fluid and an amount of second fluid, according to an example of the principles described herein.

FIG. 6 is a side cut-away block diagram of a fluidic die including an amount of initial fluid and an amount of second fluid, according to an example of the principles described herein.

FIG. 7 is a side cut-away block diagram of a fluidic die including an amount of initial fluid and an amount of second fluid, according to an example of the principles described herein.

FIG. 8 is a side cut-away block diagram of a fluidic die including an amount of second fluid after the initial fluid is purged from the fluidic die, according to an example of the principles described herein.

FIG. 9 is a flowchart showing a method of determining initial fluid purge, according to an example of the principles described herein.

FIG. 10 is a flowchart showing a method of determining initial fluid purge, according to an example of the principles described herein.

FIG. 11 is a flowchart showing a method of determining initial fluid purge, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In some examples, a fluidic delivery system may include a first fluid that may be purged and replaced with a second fluid. One way that this fluid replacement may occur is by ejecting the first fluid out of fluidic passageways of the fluidic die such as through a number of nozzles or into other passageways of the fluidic die until it has been fully purged and replaced with the second fluid. For example, a shipping fluid may be included within the fluidic die. The shipping fluid provides a means by which a second fluid may be primed into the fluidic die. If, for example, the fluidic die is not provided to an end user with the initial fluid contained therein, the fluidic die may not be able to draw the second fluid into the fluidic passageways of the fluidic die using activation of a number of actuators used to eject the fluid. In this situation where the initial fluid is not included in the fluidic die, the actuators do not have a fluid to eject from the fluidic die, and the second fluid could not be drawn into the fluidic channels. Further, there may be insufficient capillary forces available to move the secondary fluid into the fluidic channels. Therefore, the initial fluid acts as a sacrificial fluid used to draw the second fluid into the fluidic passageways for ejection from the fluidic die.

Although example provided herein describe the use of fluid ejection devices used in, for example, printing or 3D printing, the present systems and methods may be applied in other scenarios including, for example, devices used in connection with chemical and life science applications. For example, the present systems and methods may be used in connection with lab-on-chip devices where an initial fluid is used to draw a chemical or bin-chemical solution into the fluidic die for chemical or biological analysis.

In one example, the shipping fluid may be purged for a fixed amount of time. However, due to tolerances of the system and the lack of feedback to sense when all the shipping fluid has been purged, the fixed amount of time may be set to the longest possible time to ensure that the shipping fluid has been purged. This may result in continuing to purge longer than there exists shipping fluid within the fluidic die, resulting in waste of expensive secondary fluid such as printing fluid or ink and longer purge cycles that can take longer than expected by a user. Thus, a user may desire to know when the shipping fluid has been purged from the fluidic die.

Examples described herein provide a fluidic die. The fluidic die may include an electrode disposed within a fluidic passageway of the fluidic die to determine if a difference between an initially-measured impedance and a subsequently-measured impedance as measured by the electrode indicates a completion of a purging of an initial fluid from the fluidic die and a replacement with a second fluid.

The fluidic die may also include control circuitry to activate the electrode within the fluidic die. The control circuitry provides a current to the electrode where the electrode is in contact with the fluid within the fluidic die. The fluidic die may also include at least one actuator. The control circuitry activates the electrode to measure the initial impedance of the fluid within at least one fluidic channel of the fluidic die, activates the actuator to pump the fluid from the fluidic die, and activates the electrode to measure the subsequent impedance of the fluid. The control circuitry determines if the subsequent impedance is stable over a period of time, greater than a minimum expected delta from a baseline impedance of the initial fluid, or combinations thereof, and, in response to a determination that the subsequent impedance is not stable over a period of time, is not greater than a minimum expected delta from a baseline impedance of the initial fluid, or combinations thereof, activates the actuator to pump the fluid from the fluidic die.

The control circuitry, in response to a determination that the subsequent impedance is stable over a period of time, is greater than a minimum expected delta from a baseline impedance of the initial fluid, or combinations thereof determines if the subsequent impedance as measured over a plurality of electrodes across a length of the fluidic die are within a range of one another. Further, the control circuitry determines if the initial impedance or the subsequent impedance is outside a threshold stored in memory, and, in response to a determination that the initial impedance or the subsequent impedance is not outside the threshold stored in the memory, activates the actuator to pump the fluid from the fluidic die. The control circuitry, in response to a determination that the initial impedance or the subsequent impedance is outside the threshold stored in the memory, determines if the initial impedance or the subsequent impedance as measured over a plurality of electrodes across a length of the fluidic die are within a range of one another.

Examples described herein provide a fluid detection device. The fluid detection device may include a fluidic channel and at least one electrode disposed within the fluidic channel of a fluidic die and control circuitry to activate the electrode within the fluidic die to determine if a difference between an initially-measured impedance and a subsequently-measured impedance as measured by the electrode indicates a completion of a purging of initial fluid from the fluidic die.

The control circuitry continues to activate the electrode within the fluidic die based on whether the initial impedance or the subsequent impedance is stable over a period of time, whether the initial impedance or the subsequent impedance is greater than a minimum expected delta from a baseline impedance of the initial fluid, whether the initial impedance or the subsequent impedance is outside the threshold stored in memory, or combinations thereof.

Examples described herein provide a method of determining initial fluid purge. The method may include, with an electrode, measuring an initial impedance of fluid within at least one fluidic passageway of a fluidic die, purging the initial fluid from the fluidic die, and with the electrode, measuring at least one subsequent impedance of the fluid. The method may also include determining if the initial impedance and the subsequent impedance as measured by the electrode indicate a completion of a purging of the initial fluid from the fluidic die.

The method may include, with the electrode, measuring the initial impedance and subsequent impedance of the fluid within the at least one nozzle of the fluidic die. The measuring of the initial impedance may include providing a current to the electrode disposed within a fluidic passageway of the fluidic die, the electrode being in contact with the fluid within the fluidic die. The method may also include determining if the initial impedance and the subsequent impedance as measured by the electrode indicates a completion of a purging of initial fluid from the fluidic die may include deriving a baseline impedance of the initial fluid, and determining if the subsequent impedance is stable over a period of time, greater than a minimum expected delta from the baseline impedance, or combinations thereof.

The method may also include performing the method over a plurality of nozzles across a length of the fluidic die, and determining if the subsequent impedance for the plurality of nozzles are within a predetermined range of one another. Determining if the initial impedance and the subsequent impedance as measured by the electrode indicate a completion of a purging of the initial fluid from the fluidic die may include determining if the initial impedance is within a range of a value stored in memory, and, in response to a determination that the initial impedance is not within the range of the stored value, pumping the fluid from the fluidic die. The method may also include performing the method over a plurality of nozzles across a length of the fluidic die, determining if the subsequent impedance is within the range of the value stored in the memory, and in response to a determination that the subsequent impedance is not within the range of the stored value, pumping the fluid from the fluidic die.

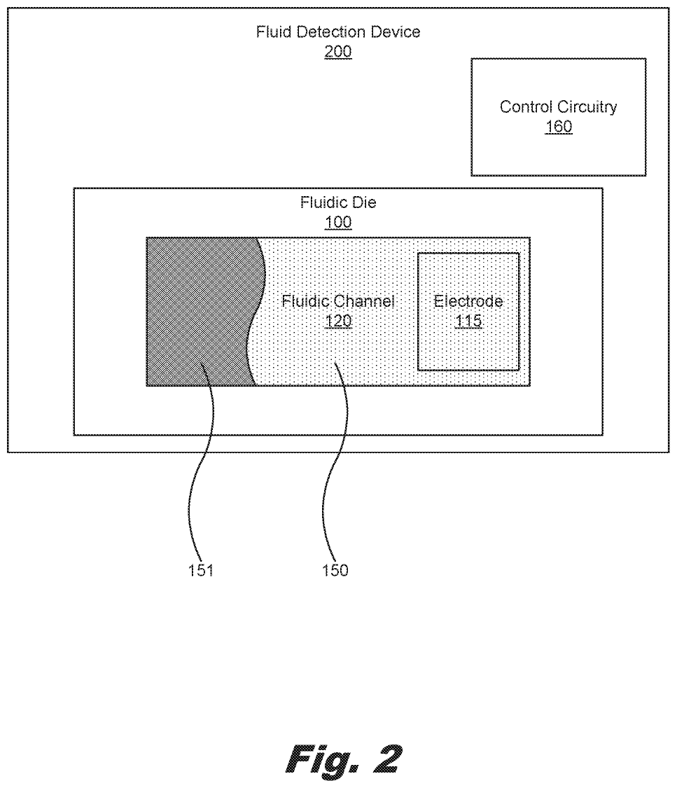

Turning now to the figures, FIG. 1 is a block diagram of a fluidic die (100), according to an example of the principles described herein. The fluidic die (100) may include, for example, any fluid ejection device that ejects a fluid onto a surface such as a printhead die of a printhead that ejects, for example, ink onto a print medium.

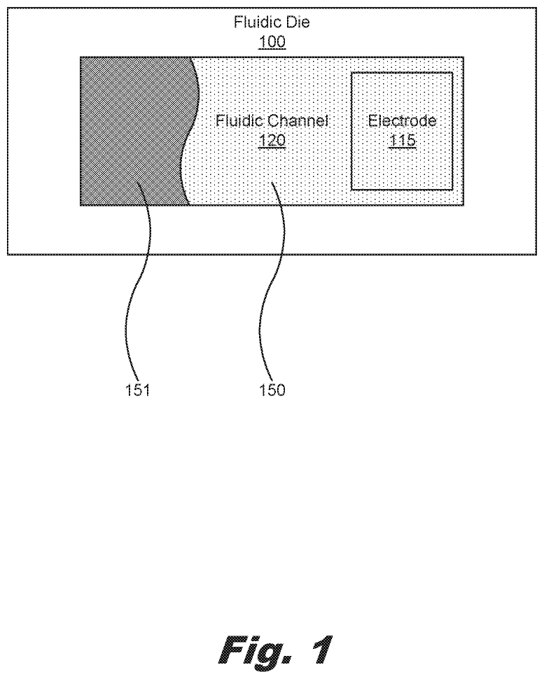

The fluidic die (100) may also include a fluidic channel (120) through which fluids may pass through the fluidic die (100) and eject from the fluidic die (100). At least one electrode (115) may be disposed within the fluidic channel (120). In one example, control circuitry (FIG. 2, 160) may be used to activate the electrode (115) within the fluidic die (100).

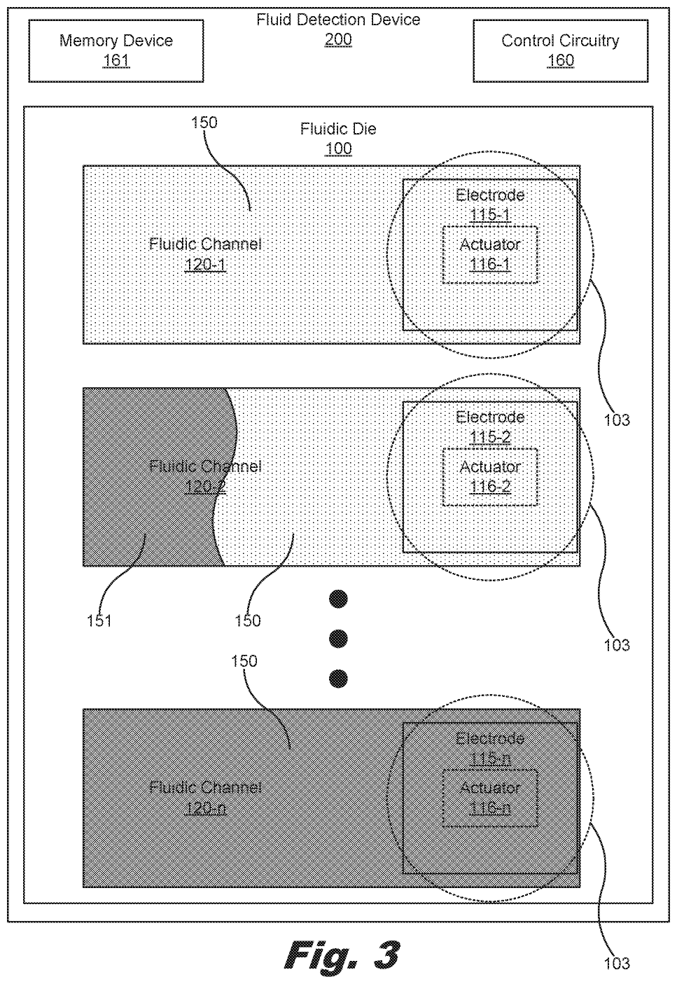

When activated by the control circuitry (FIG. 2, 160), an impedance may be sensed at the electrode (115). The sensed impedance corresponds to a particle concentration within the fluid, fluid composition, or other properties of the fluids that may be present in the fluidic die (100). The sensed impedance may be used to determine whether an initial fluid (150) has been purged from the fluidic die (100). In the examples described herein, the fluidic die (100) may be manufactured to include an initial fluid (150) that may be referred to as a shipping fluid. The initial fluid (150) may be used to ensure that the elements of the fluidic die (100) are not damaged during shipping, and, provide a means by which a second fluid (151) may be primed into the fluidic die (100). If the fluidic die (100) is not provided to an end user with the initial fluid (150) contained therein, the fluidic die (100) may not be able to draw the second fluid (151) into the fluidic channels (120) of the fluidic die (100) using activation of a number of actuators (FIG. 3, 116-1, 116-2, 116-n, collectively referred to herein as 116) used to eject the fluid. In this situation, where the initial fluid (150) is not included in the fluidic die (100), the actuators do not have a fluid to eject from the fluidic die (100), and the second fluid (151) could not be drawn into the fluidic channels (120). Further, there may be insufficient capillary forces available to move the secondary fluid (151) into the fluidic channels (120). Therefore, the initial fluid (150) acts as a sacrificial fluid used to draw the second fluid (151) into the fluidic channels (120) for ejection from the fluidic die (100).

In an example, the second fluid (151) is the fluid that is intended to be ejected from the fluidic die (100) in order to produce a printed image or, in the case of 3D printing, the object. In an example, the initial fluid (150) may also be used as an ejection fluid or may mix with the second fluid (151) without changing a number of functional characteristics of the second fluid (151) or without doing so in a significant manner. In an example, the initial fluid (150) may be purged from the fluidic die (100) completely before printing the second fluid (151) into a print medium in order to ensure that the fluid being printed onto the print medium will have a consistent print quality and may be ejected from the fluidic die (100) in a consistent manner.

The electrode (115) of the fluidic die (100) is used to detect a difference between an initially-measured impedance and a subsequently-measured impedance. The initially-measured impedance may be measured by the control circuitry (160) activating the electrode when the initial fluid (150) is present in the fluidic die (100). The subsequently-measured impedance may be measured by the control circuitry (160) activating the electrode when the initial fluid (150) and at least some volume of the second fluid (151) is present in the fluidic die (100).

The difference between the initially-measured impedance and the subsequently-measured impedance indicates a degree of completion of a purging of the initial fluid (150) from the fluidic die and a replacement of the initial fluid (150) with the second fluid (151). Due to the different chemical and physical properties of the initial fluid (150) with respect to the second fluid (151), the initial fluid (150) may have a different impedance when a current or voltage is applied to the initial fluid (150) via the electrode (115), relative to when the current or the voltage is applied to the second fluid (151). Thus, as the initial fluid (150) is being ejected from the fluidic die (100) and is replaced by the second fluid (151), a change in impedance may be detected by the electrode (115) that indicates that the initial fluid (150) is being purged from the fluidic die (100) and replaced by the second fluid (151), to what degree that process has occurred, and an indication of when the initial fluid (150) has been completely purged from the fluidic die (100). The chemical and physical properties of the initial fluid (150) and the second fluid (151) may include, for example, particle concentration that may vary due to different levels of particles in the initial fluid (150) relative to the second fluid (151), different solvents within the initial fluid (150) and second fluid (151) that include different chemicals with different impedances, other differing chemical and physical properties, or combinations thereof.

In an example, a current may be applied to the electrode (115) when the initial fluid (150) and the second fluid (151) are to be detected, and a voltage may be measured. Conversely, in another example, a voltage may be applied to the electrode (115) when the initial fluid (150) and second fluid (151) are to be detected, and a current may be measured. The voltage applied to the electrode (115) may be a non-nucleating and non-drive-bubble-forming pulse. In contrast, when a portion of the fluid (150) is to be ejected from the fluidic die (100), an actuator (FIG. 3, 116) may be actuated to create a drive bubble as described herein. In other words, the current or voltage applied to the electrode (115) to make an impedance measurement may be independent from the voltage (or current) applied to the actuator (FIG. 3, 116) to create nucleation and eject a drop.

The impedance of the fluids may be measured in two ways. A first, non-nucleating process may include not firing the actuator (FIG. 3, 116), and forcing a current or voltage onto the electrode (115) for a period of time, A first process measures the static (steady state) fluid impedance since the fluid is not being perturbed, A second process to measure impedance and determine if the initial fluid (150) or the second fluid (151) is present is to fire the actuator (FIG. 3, 116), which forms a drive bubble (i.e., a nucleation event), and then to force current or voltage into the electrode (115) for a period of time at a specific time during the nucleation event. This measures the drive bubble characteristic impedance of the fluid (150, 151), which may be different for the initial fluid (150) and the second fluid (151) since they have different properties.

Thus, in one example, a fixed current may be applied to the fluid surrounding the electrode (115), and a resulting voltage at the electrode (115) may be sensed. The sensed voltage may be used to determine an impedance of the fluid surrounding the electrode (115) at that area within the fluidic die (100) at which the electrode (115) is located. Electrical impedance is a measure of the opposition that the circuit formed from the electrode (115) and the fluid presents to a current when a voltage is applied to the electrode (115), and may be represented as follows:

$$Z = \frac{V}{I} \qquad Eq . 1$$

where Z is the impedance in ohms (Ω), V is the voltage applied to the electrode (115), and I is the current applied to the fluid (150, 151) surrounding the electrode (115). In another example, the impedance may be complex in nature, such that there may be a capacitive element to the impedance where the fluid (150, 151) may act partially like a capacitor. A measured capacitance in this example may change with the properties of the fluid (150, 151) such as particle concentration.

In one example, the detected impedance (Z) may be proportional or may correspond to a particle concentration, fluid concentration, or other property of the fluid in the initial fluid (150) and the second fluid (151). Stated in another way, the impedance (Z) may be proportional or correspond to a dispersion level of the particles within the fluid vehicle of the initial fluid (150) and the second fluid (151). In one example, if the impedance is relatively lower, this may indicate that a higher particle concentration exists within the fluid in that area at which the impedance is detected. Conversely, if the impedance is relatively higher, this may indicate that a lower particle concentration exists within the fluid in that area at which the impedance is detected. This information may be used to differentiate between the initial fluid (150) and the second fluid (151), may be used to indicate at what levels the initial fluid (150) exists within the fluidic channels (120) in proportion to the second fluid (151), and may be used to indicate when the initial fluid (150) has been completely purged from the fluidic die (100) of the fluidic die (100).

FIG. 2 is a block diagram of a fluid detection device (200), according to an example of the principles described herein. The fluid detection device (200) may include at least one electrode (115) disposed within a fluidic channel (120) of a fluidic die (100) as described above in connection with FIG. 1. The fluid detection device (200) may also include control circuitry (160) to activate the electrode (115) within the fluidic die (100) to determine if a difference between an initially-measured impedance and a subsequently-measured impedance as measured by the electrode (115) indicates a completion of a purging of initial fluid (150) from the fluidic die (100).

In one example, the control circuitry (160) may continue to activate the electrode (115) within the fluidic die (100) based on whether the initial impedance and/or the subsequent impedance is stable over a period of time, whether the initial impedance and/or the subsequent impedance is greater than a minimum expected delta from a baseline impedance of the initial fluid, whether the initial impedance or the subsequent impedance is greater than the threshold stored in a memory (FIG. 3, 161), or combinations thereof. The control circuitry (160) provides a current to the electrode (115). The electrode (115) is in contact with the fluid (150, 151) within the fluidic die (100).

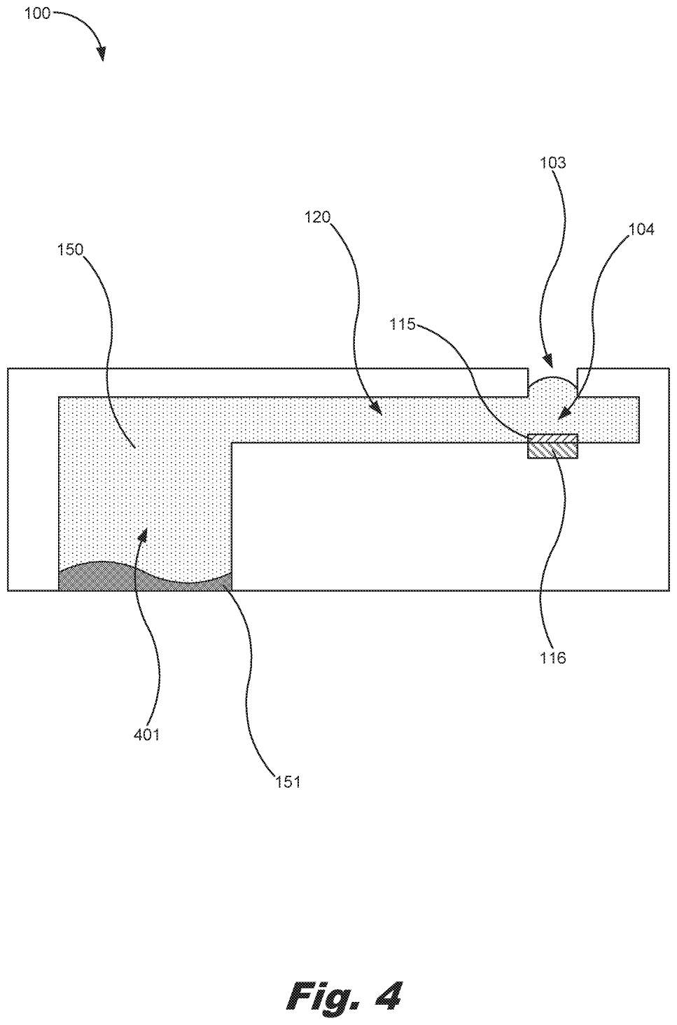

FIG. 3 is a block diagram of a fluid detection device (200), according to an example of the principles described herein. The fluid detection device (200) may include a fluidic die (100) with a plurality of fluidic channels (120-1, 120-2, 120-n, collectively referred to herein as 120). Each fluidic channel (120) may include an electrode (115-1, 115-2, 115-n, collectively referred to herein as 115) and an actuator (116-1, 116-2, 116-n, collectively referred to herein as 116). The actuators (116) may be any device used to eject a volume of the fluid (150, 151) from the ejection chamber (FIG. 4, 104), out a nozzle (103), and onto a media, for example. Within FIG. 3 and throughout the remaining description and figures, the designation “n” indicates that any number of that number from one to infinity may exist within the fluid detection device (200).

The actuators (116) may be, for example, thermal heating devices used to form a drive bubble of vaporized fluid separated from liquid fluid by a bubble wall. The drive bubble may be used to force the fluid from the fluid ejection chamber (FIG. 4, 104) and out the nozzle (103). Once the drive bubble collapses, additional fluid from a reservoir may flow into the fluid slots (FIG. 4, 106), fluid channels (FIG. 4, 105), and fluid ejection chambers (FIG. 4, 104), replenishing the lost fluid volume from the creation of the drive bubble and the ejection of the fluid. This process may be repeated each time the fluidic die (100) is instructed to eject fluid.

In another example, the actuators (116) may be piezoelectric actuators to generate a pressure pulse that forces a volume of the fluid (150, 151) out of the nozzle (103). In this example, the piezoelectric actuators may include a piezoelectric material that has a polarization orientation that provides a motion into the fluid ejection chambers (FIG. 4, 104) when and electrical charge is applied to the piezoelectric material.

In the example of FIG. 3, the electrodes (115) and actuators (116) are collocated where the actuator (116) is underneath the electrode (115) with respect to the nozzle (103) as indicated by the dashed lines of the block designating the actuator (116), The nozzle (103) is located above the electrode (115) and actuator (116) such that the fluid (150, 151) is ejected out of the fluidic channel (120) through the nozzle (103) using the actuator (116) and in a direction towards the viewer of FIG. 3. In another example, nozzle (103) may be located off axis with respect to a common alignment axis of the electrode (115) and actuator (116). Further, in an example, the electrode (115) may be located off axis with respect to a common alignment axis of the nozzle (103) and actuator (116) and at another location within the fluidic channel (120).

In the example of FIG. 3, the fluid detection device (200) may include a memory device (161) used in connection with the control circuitry (160) to control the activation of the electrodes (115) and actuators (116) within the fluidic die (100), The control circuitry (160) activates the electrodes (115) according to the various methods and description provided herein. For example, the control circuitry (160) activates the electrodes (115) to measure an initial and/or subsequent impedance of the fluids (150, 151) within at least one fluidic channel (120) of the fluidic die (100). Further, the control circuitry (160) activates the actuator (116) to pump or purge the fluids (150, 151) from the fluidic die (100).

The control circuitry (160) may also determine if a subsequent impedance as measure by the electrode (115) and the control circuitry (160) is stable over a period of time, greater than a minimum expected delta from a baseline impedance of the initial fluid (150), or combinations thereof. In response to a determination that the subsequent impedance is not stable over a period of time, is not greater than a minimum expected delta from a baseline impedance of the initial fluid (150), or combinations thereof, activates the actuators (116) to pump or purge or continue to pump or purge the initial fluid (150) from the fluidic die (100). Further, the control circuitry (160), in response to a determination that the subsequent impedance is stable over a period of time, is greater than a minimum expected delta from a baseline impedance of the initial fluid (150), or combinations thereof determines if the subsequent impedance as measured over a plurality of electrodes (115-1, 115-2, 115-n) across a length of the fluidic die (100) are within a range of one another.

Further, the control circuitry (160) determines if the initial impedance or the subsequent impedance is outside a threshold stored in the memory device (161). The memory device (161) may be included in the fluid detection device (200) as depicted in FIG. 3, or may be located on a printing device associated with the fluid detection device (200), In response to a determination that the initial impedance or the subsequent impedance is not outside the threshold stored in the memory device (161), the control circuitry (160) may activate the actuator (116) to pump or purge the initial fluid (150) from the fluidic die (100) until the impedance of the fluid (150, 151) is measured and indicates that the initial fluid (150) has been pumped out of or purged from the fluidic die (100) and replaced by the second fluid (151).

The control circuitry (160), in response to a determination that the initial impedance or the subsequent impedance is greater than the threshold stored in the memory device (161), may determine if the initial impedance or the subsequent impedance as measured over a plurality of electrodes (115) across a length of the fluidic die (100) are within a range of one another. By making this determination, the fluid detection device (200) may determine whether all of the initial fluid (150) has been pumped out of or purged from the entirety of the fluidic die (100).

FIGS. 4 through 8 are a side cut-away block diagrams of a fluidic die including various amounts of the initial fluid (150) and the second fluid (151), according to an example of the principles described herein, FIGS. 4 through 8 depict the fluidic die (100) are various stages of initial fluid (150) purging and replacement of the initial fluid (150) by the second fluid (151). In FIG. 4, the initial fluid (150) is present within a fluid slot (401), the fluidic channel (120), and a fluid ejection chamber (104). The second fluid (151) is present in the fluidic die (100), but not within the fluid slot (401) in a significant amount. When the actuator (116) is activated, the initial fluid (150) is ejected from the ejection chamber (115) and out the fluidic die (100). The electrode (115) may also be activated to detect the impedance of the initial fluid (150). The detection of the impedance of the initial fluid (150) may be performed before the fluidic die (100) begins purging the initial fluid (150) from the fluidic die (100). In this manner, an initial impedance that serves as a baseline impedance may be obtained in order to detect changes in the impedance as the initial fluid (150) is purged from the fluidic die (100) and is replaced by the second fluid (151).

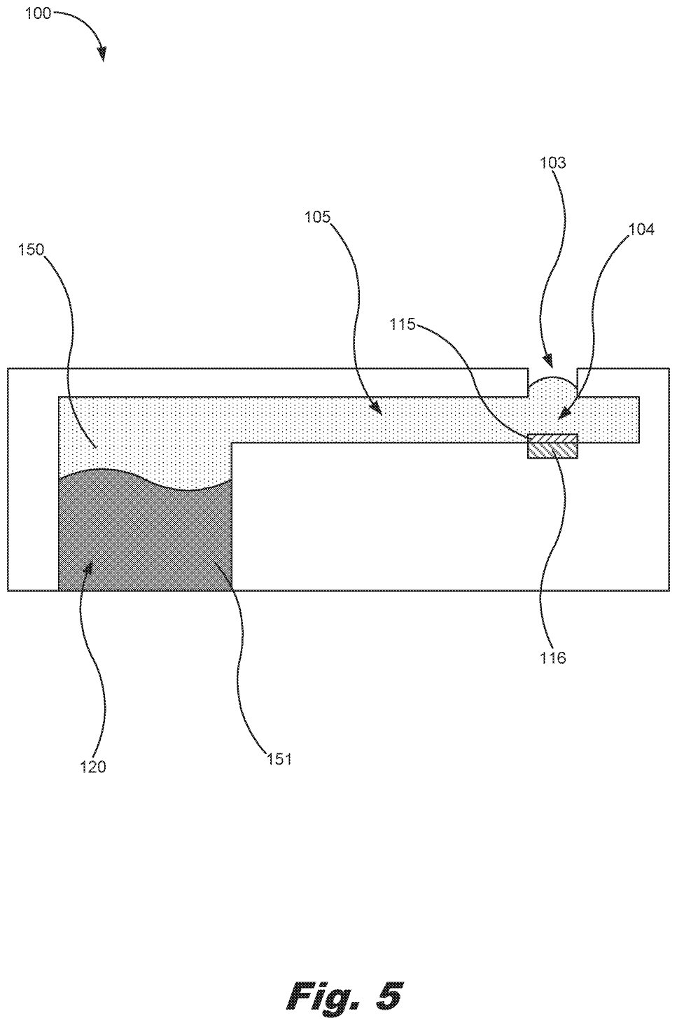

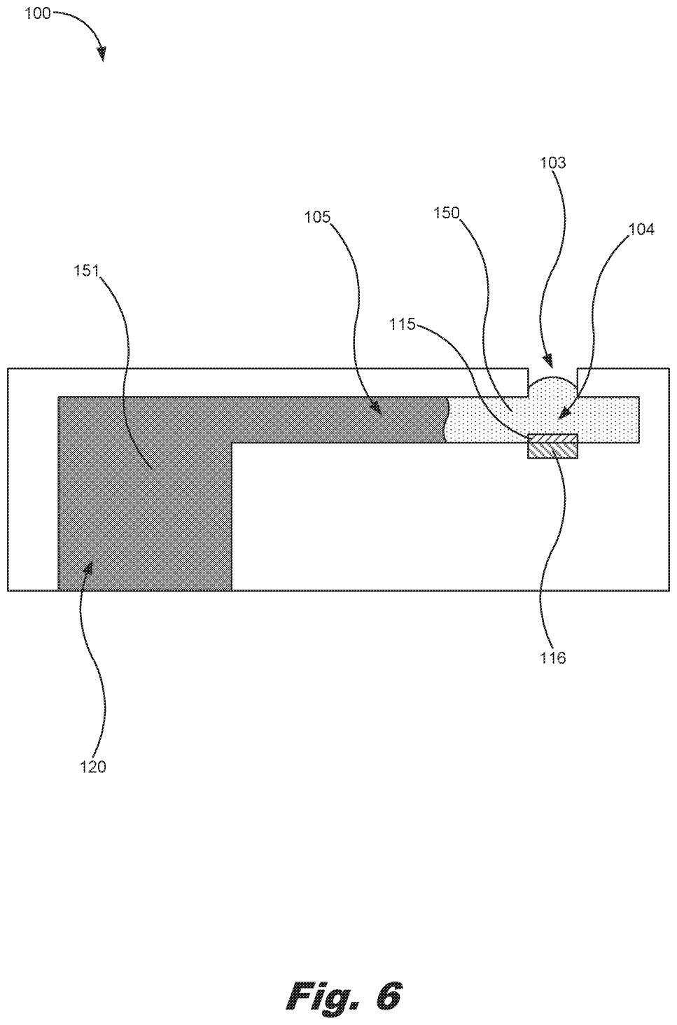

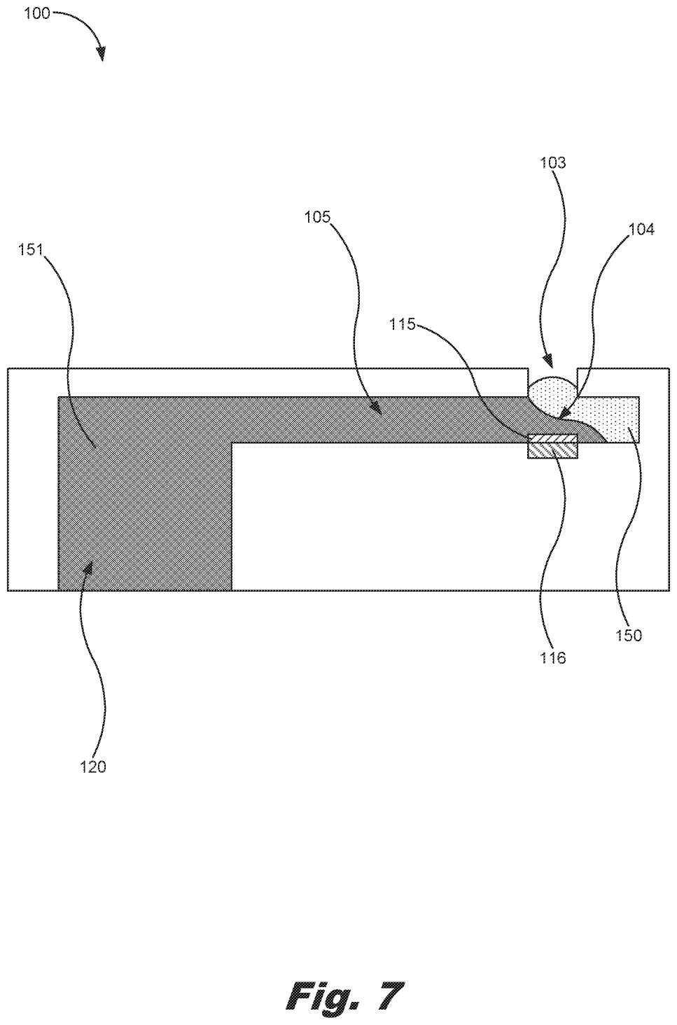

FIGS. 5, 6, and 7 depict the fluidic die (100) at different stages at which the initial fluid (150) has been purged from the fluidic die (100) and the second fluid (151) is entering the fluid slot (401) in FIG. 5, the fluidic channel (120) in FIG. 6, and the fluid ejection chamber (104) in FIG. 7, In an example, the electrode (115) is able to detect the change of impedance in the fluid (150, 151) within the fluid slot (401), the fluidic channel (120), and the fluid ejection chamber (104) as the secondary fluid (151) enters any of these fluidic passageways because the ground through the fluids (150, 151) within these fluidic passageways. As used herein, the term “fluidic passageway” includes the fluid slot (401), the fluidic channel (120), the fluid ejection chamber (104), and combinations thereof. Thus, the electrode (115) is able to detect the change in impedance of the fluids (150, 151) when the second fluid (151) is first introduced into one of these fluidic passageways.

In an example, the initial fluid (150) or the second fluid (151) may include a taggant. A taggant is any chemical or physical marker added to the initial fluid (150) or second fluid (151) that allows for various forms of testing to occur to the fluids (150, 151) including the detection of the fluids (150, 151) using the electrode (115) and the currant or voltage applied to the fluids (150, 151). Because printing quality of the initial fluid (150) as a shipping fluid is not a concern as it is not to be used to print images onto a substrate, the taggant may be included in the initial fluid (150) to modify detectable attributes of the initial fluid (150) including fluid conductivity while not affecting the desirable attributes of the initial fluid (150) as a shipping fluid. The electrode (115) may be able to distinguish between the fluids (150, 151) using the taggant or not using a taggant. In one example, both the chemical makeup of the fluids (150, 151) and the different chemical properties of the fluids (150, 151) may be used together to distinguish between the two fluids (150, 151).

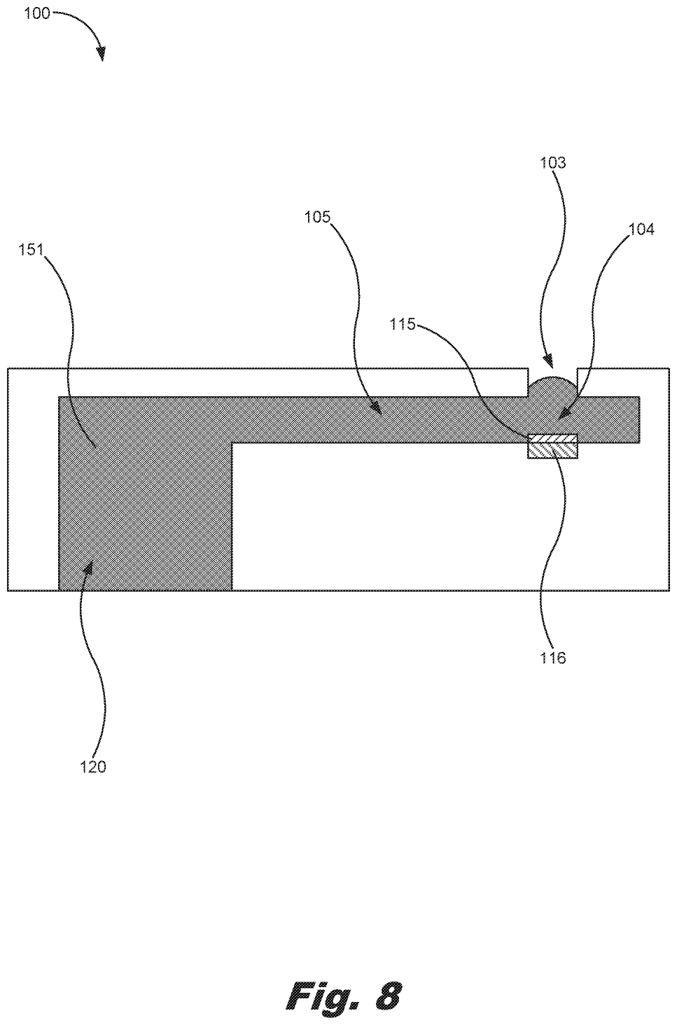

Eventually, all the initial fluid (150) is purged from the fluidic die (100) and is replaced entirely by the second fluid (151) as depicted in FIG. 8. FIG. 8 is a side cut-away block diagram of the fluidic die (100) including an amount of second fluid (151) after the initial fluid (150) is purged from the fluidic device, according to an example of the principles described herein. As the initial fluid (150) is ejected from the nozzle (103), the initial fluid (150) is completely purged from all the fluidic passageways of the fluidic die (100) and the impedance of the fluid (151) within the fluidic passageways of the fluidic die (100) including the fluid slot (401), the fluidic channel (120), and the fluid ejection chamber (104) is indicative of a complete purging of the initial fluid (150) and denotes that the second fluid (151) is the only fluid within these fluidic passageways. In one example, the control circuitry (FIG. 3, 160) may measure the impedance in the fluidic passageways to determine whether the impedance has reached a threshold defined and stored in the memory (161) of the fluid detection device (200). Once the impedance crosses a threshold or is within a defined range from that threshold, it may be determined that the initial fluid (150) has been purged from the fluidic die (100) and replaced with the second fluid (151). In another example, the control circuitry (FIG. 3, 160) may measure the impedance in the fluidic passageways to determine if the impedance of the fluid (150, 151) is stable, greater than a minimum expected delta from a previously-measured baseline impedance, or combinations thereof. In these examples, once the criteria has been met, it may be determined that the initial fluid (150) has been purged from the fluidic die (100) and replaced by the second fluid (151),

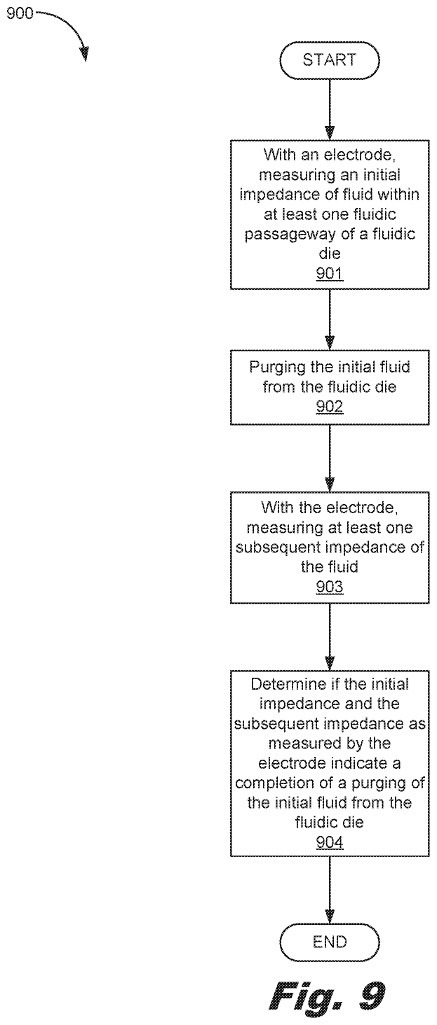

FIG. 9 is a flowchart (900) showing a method of determining initial fluid (150) purge, according to an example of the principles described herein. The method (900) may include, with an electrode (115), measuring (block 901) an initial impedance of the fluid (150, 151) within at least one fluidic passageway (104, 120, 401) of a fluidic die (100). The initial fluid (150) may be purged (block 902) from the fluidic die (100) by the control circuitry (160) activating the actuators (116) within the fluidic die (100).

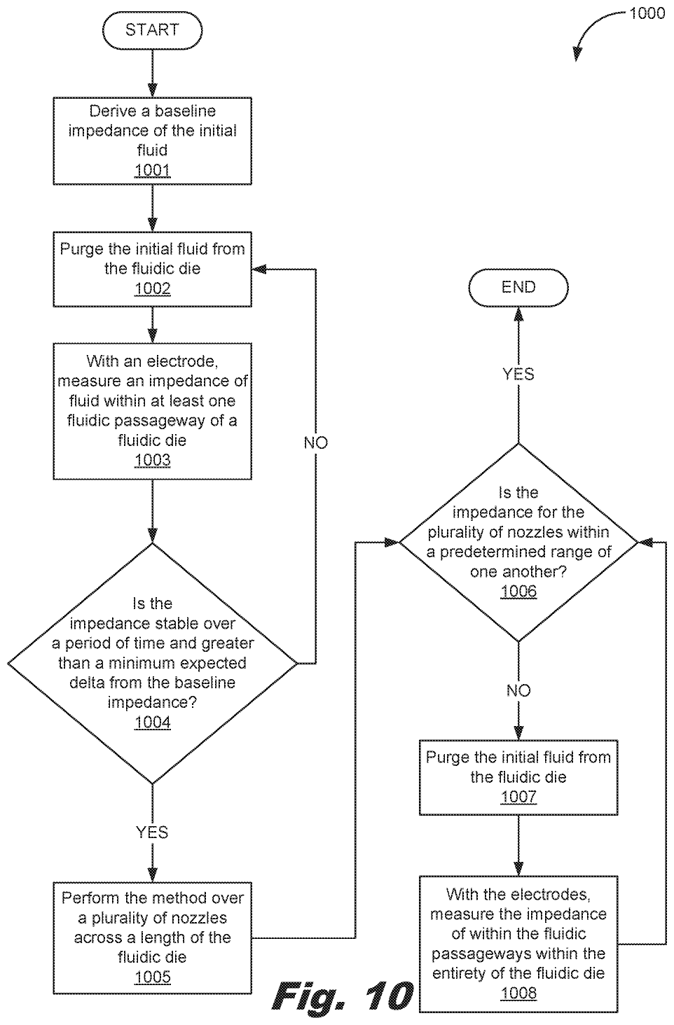

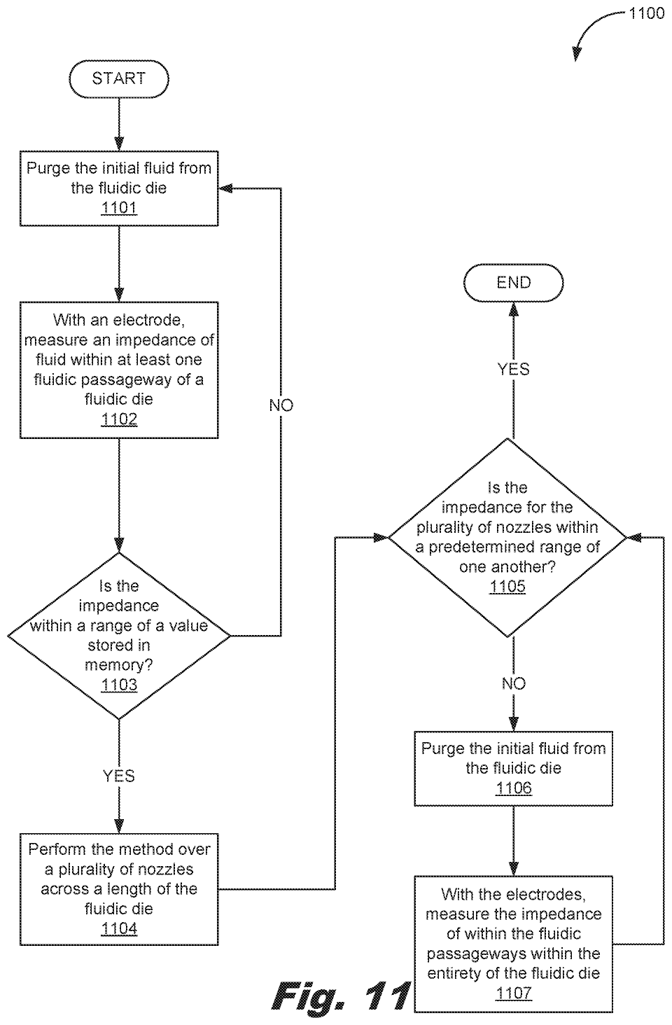

The control circuitry (FIG. 3, 160) may activate the electrodes (115) within the fluidic die (100) to measure (block 903) at least one subsequent impedance of the fluid (150, 151). It may then be determined (block 904) if the initial impedance and the subsequent impedance as measured by the electrodes (115) indicate a completion of a purging of the initial fluid (150) from the fluidic die (100). More details regarding different methods of detecting the purging of the initial fluid (150) from the fluidic die (100) and the replacement of the initial fluid (150) with the second fluid (151) is provided in connection with FIGS. 10 and 11.

FIG. 10 is a flowchart showing a method (1000) of determining initial fluid (150) purge, according to an example of the principles described herein. The method of FIG. 10 may begin by deriving a baseline impedance of the initial fluid (150). This baseline impedance defines the impedance of the initial fluid (150) without the inclusion of the secondary fluid (151) at any volume therein. In one example, the baseline impedance may be obtained from empirical data obtained from analysis of the initial fluid (100) outside of the fluidic die (100) or the fluid detection device (200). In another example, the baseline impedance may be determined by activating the electrodes (115) before the initial fluid (150) is dispensed from the fluidic die (100) or any volume of the second fluid (151) is introduced into the fluidic die (100). With this baseline impedance, any variance from the baseline impedance is indicative of the inclusion of some volume of the second fluid (151) within the fluidic die (100).

The method may continue with the purging (block 1002) of the initial fluid (150) from the fluidic die (100). In one example, the purging (block 1002) may begin when it is determined that a source for the second fluid (151) is available as a fluid input to the fluidic die (100). In this example, the fluidic die (100) may be a portion of a commercial grade printing device where the fluidic die (100) is a separate part or element of the printing device relative to a fluid reservoir containing a volume of the second fluid (151). In another example, the purging (block 1002) may begin when the baseline impedance has been derived (block 1001). In this example, the printing device may be a desktop printing device that includes a printhead comprising a reservoir containing the second fluid (151) that is fluidically coupled to the fluidic die (100).

Purging (block 1002) of the initial fluid (150) includes activation of the actuators (116) to eject the fluid form the nozzles (103). The impedance may be measured (block 1003) within at least one fluidic passageway (104, 120, 401) within the fluidic die (100). At any time during the purging (block 1002), the impedance may be measured (block 1003), Further, the impedance may be measured (block 1003) at any location within the fluidic passageways (104, 120, 401), and at any frequency.

It may be determined (block 1004) whether the impedance has been stable over a period of time, greater than a minimum expected delta from the baseline impedance derived at block 1001, or combinations thereof. The minimum expected delta may be empirically derived by determining the difference in impedance values for the initial fluid (150) and the second fluid (151). This minimum expected delta may be stored, for example, in the memory device (161) of the fluid detection device (200) for use by the control circuitry (160) in determining when to activate the actuators (116) and electrodes (115).

In response to the determination (block 1004, determination NO) that the impedance has not been stable over a period of time, greater than a minimum expected delta from the baseline impedance derived at block 1001, or combinations thereof, then the control circuitry (160) may continue to activate the actuators (116) to purge (block 1002) the initial fluid (150) from the fluidic die (100). A subsequent measurement of the impedance may be made at block (1003), and the determination of block 1004 may be made again. This loop between blocks 1002 through 1004 and the “NO” determination at block 1004 may be made any number of times and at any frequency until it is determined that at the determination (block 1004, determination YES) that the impedance has been stable over a period of time, greater than a minimum expected delta from the baseline impedance derived at block 1001, or combinations thereof.

The above process including blocks 1001 through 1004 may be performed (block 1005) over a plurality of nozzles (103) across a length of the fluidic die (100). A determination (block 1006) may be made as to whether the impedance measured at all of the nozzles (103) and their associated actuators (116) and electrodes (115) are within a predetermined range of one another. In response to the determination (block 1006, determination NO) that the impedance measured at all of the nozzles (103) and their associated actuators (116) and electrodes (115) are not within a predetermined range of one another, then the control circuitry (160) may continue to activate the actuators (116) to purge (block 1007) the initial fluid (150) from the fluidic die (100), A subsequent measurement of the impedance may be made at block (1008) using all the electrodes (115) within the fluidic passageways (104, 120, 401) of the fluidic die (100), and the determination of block 1006 may be made again. This loop between blocks 1006 through 1008 and the “NO” determination at block 1006 may be made any number of times and at any frequency until it is determined (block 1006, determination YES) that the impedance measured at all of the nozzles (103) and their associated actuators (116) and electrodes (115) are is within a predetermined range of one another. The determination “YES” at block 1006 indicates that the initial fluid (150) has been purged from all the fluidic passageways (104, 120, 401) of the fluidic die (100), or has been purged to a level that is insignificant to a desired degree of print quality.

FIG. 11 is a flowchart showing a method (block 1100) of determining initial fluid (150) purge, according to an example of the principles described herein. The method of FIG. 11 may begin by purging (block 1101) the initial fluid (150) from the fluidic die (100). In one example, the purging (block 1101) may begin when it is determined that a source for the second fluid (151) is available as a fluid input to the fluidic die (100). In this example, the fluidic die (100) may be a portion of a commercial grade printing device where the fluidic die (100) is a separate part or element of the printing device relative to a fluid reservoir containing a volume of the second fluid (151), In another example, the printing device may be a desktop printing device that includes a printhead comprising a reservoir containing the second fluid (151) that is fluidically coupled to the fluidic die (100). In this example, the purging (block 1101) may take place when the printhead is installed within the printing device and instructed to begin a setup of the printhead that may include an initial fluid (150) purging process.

Purging (block 1101) of the initial fluid (150) includes activation of the actuators (116) to eject the fluid form the nozzles (103). The impedance may be measured (block 1102) within at least one fluidic passageway (104, 120, 401) within the fluidic die (100). At any time during the purging (block 1101), the impedance may be measured (block 1102), Further, the impedance may be measured (block 1102) at any location within the fluidic passageways (104, 120, 401), and at any frequency.

It may be determined (block 1103) whether the impedance is within a range of a value stored in the memory (161) of the fluid detection device (200). The stored value may define a threshold impedance that is indicative of the complete purging of the initial fluid (150) from the fluidic passageways (104, 120, 401) within the fluidic die (100) and replacement of the initial fluid (150) by the second fluid (151). The stored value may be empirically derived by determining the impedance value of the initial fluid (150) and/or the second fluid (150). The derived impedance of the initial fluid (150) may be used to differentiate the derived impedance of the second fluid (151), and the impedance value of the second fluid (151) may be the stored value within the memory (161).

In response to the determination (block 1103, determination NO) that the impedance is not within a range of a value stored in the memory (161) of the fluid detection device (200), the control circuitry (160) may continue to activate the actuators (116) to purge (block 1102) the initial fluid (150) from the fluidic die (100). A subsequent measurement of the impedance may be made at block (1102), and the determination of block 1103 may be made again. This loop between blocks 1101 through 1103 and the “NO” determination at block 1103 may be made any number of times and at any frequency until it is determined that at the determination (block 1103, determination YES) that the impedance is within a range of a value stored in the memory (161) of the fluid detection device (200).

The above process including blocks 1101 through 1103 may be performed (block 1104) over a plurality of nozzles (103) across a length of the fluidic die (100). A determination (block 1105) may be made as to whether the impedance measured at all of the nozzles (103) and their associated actuators (116) and electrodes (115) are within a predetermined range of one another. In response to the determination (block 1105), determination NO) that the impedance measured at all of the nozzles (103) and their associated actuators (116) and electrodes (115) are not within a predetermined range of one another, then the control circuitry (160) may continue to activate the actuators (116) to purge (block 1106) the initial fluid (150) from the fluidic die (100). A subsequent measurement of the impedance may be made at block (1107) using all the electrodes (115) within the fluidic passageways (104, 120, 401) of the fluidic die (100), and the determination of block 1105 may be made again. This loop between blocks 1105 through 1107 and the “NO” determination at block 1105 may be made any number of times and at any frequency until it is determined (block 1105, determination YES) that the impedance measured at all of the nozzles (103) and their associated actuators (116) and electrodes (115) are is within a predetermined range of one another. The determination “YES” at block 1105 indicates that the initial fluid (150) has been purged from all the fluidic passageways (104, 120, 401) of the fluidic die (100), or has been purged to a level that is insignificant to a desired degree of print quality.

In one example of the systems and methods described herein, the electrodes (115) may also be used to determine whether the second fluid (151) that has been introduced into the fluidic die (100) an intended fluid. The chemical properties of the second fluid (151) may be distinguished from other possible second fluids that may be introduced into the fluidic die (100) due to the difference in impedance of the correct second (151) and a different second fluid. This allows for the ability to determine if a correct ink or other electable fluid has been drawn into the fluidic die (100). In one example, the control circuitry (160) may cause the electrodes to activate and determine the impedance of the second fluid (151). A value of the intended impedance of the second fluid may be stored within the memory device (161), and the control circuitry may compare the detected impedance of the second fluid (151) with the stored value of the intended impedance of the second fluid to determine if the values are similar within a range to indicate whether the correct fluid has been introduced into the fluidic die (100). This example allows for the detection of counterfeit or warranty-voiding fluids within the fluidic die.

The specification and figures describe a fluidic die. The fluidic die may include an electrode disposed within a fluidic passageway of the fluidic die to determine if a difference between an initially-measured impedance and a subsequently-measured impedance as measured by the electrode indicates a completion of a purging of an initial fluid from the fluidic die and a replacement with a second fluid. The systems and methods described herein reduces purge time for new fluidic dies, and saves in cost of the second fluid such as an ink. Detects if wrong ink is in the system.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluidic die, comprising:
a fluidic channel; and
an electrode disposed within a fluidic channel of the fluidic die to determine if a difference between an initially-measured impedance and a subsequently-measured impedance as measured by the electrode indicates a completion of a purging of an initial fluid from the fluidic die and a replacement with a second fluid.

2. The fluidic die of claim 1, comprising control circuitry to activate the electrode within the fluidic die, wherein the control circuitry provides a current to the electrode, the electrode being in contact with the initial fluid or the second fluid within the fluidic die.

3. The fluidic die of claim 1, wherein the fluidic die comprises:
at least one actuator,
wherein the control circuitry:
activates the electrode to measure the initial impedance of the initial fluid or the second fluid within at least one fluidic channel of the fluidic die;
activates the actuator to pump the initial fluid from the fluidic die; and
activates the electrode to measure the subsequent impedance of the initial fluid or the second fluid.

4. The fluidic die of claim 3, wherein the control circuitry:
determines if the subsequent impedance is stable over a period of time, greater than a minimum expected delta from a baseline impedance of the initial fluid, or combinations thereof; and
in response to a determination that the subsequent impedance is not stable over a period of time, is not greater than a minimum expected delta from a baseline impedance of the initial fluid, or combinations thereof, activates the actuator to pump the fluid from the fluidic die.

5. The fluidic die of claim 4, wherein the control circuitry, in response to a determination that the subsequent impedance is stable over a period of time, is greater than a minimum expected delta from a baseline impedance of the initial fluid, or combinations thereof determines if the subsequent impedance as measured over a plurality of electrodes across a length of the fluidic die are within a range of one another.

6. The fluidic die of claim 3, wherein the control circuitry:
determines if the initial impedance or the subsequent impedance is outside a threshold stored in memory; and
in response to a determination that the initial impedance or the subsequent impedance is not outside the threshold stored in the memory, activates the actuator to pump the fluid from the fluidic channel.

7. The fluidic die of claim 4, wherein the control circuitry, in response to a determination that the initial impedance or the subsequent impedance is greater than the threshold stored in the memory, determines if the initial impedance or the subsequent impedance as measured over a plurality of electrodes across a length of the fluidic die are within a value range.

8. A fluid detection device, comprising:
at least one electrode disposed within a fluidic channel of a fluidic die; and
control circuitry to activate the electrode within the fluidic die to determine if a difference between an initially-measured impedance and a subsequently-measured impedance as measured by the electrode indicates a completion of a purging of initial fluid from the fluidic die.

9. The fluid detection device of claim 8, wherein the control circuitry continues to activate the electrode within the fluidic die based on whether the initial impedance or the subsequent impedance is stable over a period of time, whether the initial impedance or the subsequent impedance is greater than a minimum expected delta from a baseline impedance of the initial fluid, whether the initial impedance or the subsequent impedance is greater than the threshold stored in memory, or combinations thereof.

10. A method of determining initial fluid purge, comprising:
with an electrode, measuring an initial impedance of fluid within at least one fluidic channel of a fluidic die;
purging the initial fluid from the fluidic die; and
with the electrode; measuring at least one subsequent impedance of the fluid;
determining if the initial impedance and the subsequent impedance as measured by the electrode indicate a completion of a purging of the initial fluid from the fluidic die.

11. The method of claim 10, wherein, with the electrode, measuring the initial impedance and subsequent impedance of the fluid within at least one nozzle of the fluidic die comprises providing a current to the electrode disposed within the at least one fluidic channel of the fluidic die, the electrode being in contact with the fluid within the fluidic die.

12. The method of claim 11, wherein determining if the initial impedance and the subsequent impedance, as measured by the electrode, indicates a completion of a purging of initial fluid from the fluidic die comprises:
deriving a baseline impedance of the initial fluid; and
determining if the subsequent impedance is stable over a period of time, greater than a minimum expected delta from the baseline impedance, or combinations thereof.

13. The method of claim 12, comprising:
performing the method over a plurality of nozzles across a length of the fluidic die; and
determining if the subsequent impedance for the plurality of nozzles are within a predetermined range of one another.

14. The method of claim 11, wherein determining if the initial impedance and the subsequent impedance, as measured by the electrode, indicate a completion of a purging of the initial fluid from the fluidic die comprises:
determining if the initial impedance is within a range of a value stored in memory; and
in response to a determination that the initial impedance is not within the range of the stored value, pumping the fluid from the fluidic die.

15. The method of claim 14, comprising:
performing the method over a plurality of nozzles across a length of the fluidic die;
determining if the subsequent impedance is within the range of the value stored in the memory; and
in response to a determination that the subsequent impedance is not within the range of the stored value, pumping the fluid from the fluidic die.
